(19) United States
(12) Patent Application Publication
(10) Pub. No.: US 2009/0030794 A1
(43) Pub. Date: Jan. 29, 2009

(54) ONLINE MARKETING TOOL USING VIDEOS TO PROMOTE PRINTABLE COUPONS

(75) Inventors: Irit Scheflan, Township of Washington, NJ (US); Arnon Scheflan, Township of Washington, NJ (US); James Nicholas Martin, New York, NY (US)

Correspondence Address: FOX ROTHSCHILD LLP;New York, 2000 Market Street, Tenth Floor, Philadelphia, PA, 19103, US

(73) Assignee: ONE ON ONE ADS, INC.

(21) Appl. No.: 12/177,817

(22) Filed: Jul. 22, 2008

Related U.S. Application Data
(60) Provisional application No. 60/951,452, filed on Jul. 23, 2007.

(51) Int. Cl. G06Q 30/00

(52) U.S. Cl. 705/14

(57) ABSTRACT

A webpage file is transmitted to a client computer. The webpage file includes primary content and code to load and launch a video. When the user clicks on the video, a corresponding coupon appears in a form. The user may print this coupon and later redeem it at a store or an e-commerce website. Both the videos and the coupons are provided from a server or respective servers in response to a campaign identifier provided by the client computer.

### CROSS-REFERENCE TO RELATED APPLICATIONS

This application claims the benefit of U.S. Provisional Application 60/951,452 filed on Jul. 23, 2007, the teachings of which are incorporated herein by reference.

### FIELD OF THE INVENTION

The present invention relates generally to Internet advertising. More particularly, the present invention discloses a system and related method for displaying promotional videos that permits a user to view and print coupons.

### BACKGROUND OF THE INVENTION

The Internet (or World Wide Web) has become a significant research tool for consumers seeking information on products and services. Consequently, the Internet has also become a key advertising market. Promoting products and services on the Internet, however, is difficult. Accordingly, there is an immediate need for improved methods and systems for delivery of advertising content to users that is more interesting to users.

### SUMMARY OF THE INVENTION

The present invention discloses an advertising method that presents coupons to a user when the user clicks upon a video, which creates interaction with the advertisement. The video displays a presenter that encourages the user to click on the video to receive discounts or the like in the form of a printable coupon, click through and other options provided by a graphic template that is presented on the screen. In preferred embodiments, if the user clicks upon the coupon template, the user can be either directed to buy the discounted product in a related online store by uploading the page that presents the discounted product ready to be purchased, or the user can click on a “Print” button displayed on the coupon template and the coupon is printed and may subsequently be redeemed, for example, in a standard bricks-and-mortar store. Preferably the video presents a celebrity promoting the goods or services being advertised. The goods or services thus obtain celebrity endorsement and in this manner more consumer interest and more sales are generated for the advertised product, either at the online store or in the brick and mortar stores.

Preferred embodiment methods provide an advertising method that employs video and coupons to generate customer interest. In certain embodiments the advertising method includes receiving webpage data at a client computer. The webpage data is processed by the client computer to create a webpage. The client computer extracts a campaign identifier from the webpage data and then transmits this campaign identifier to a campaign server to obtain corresponding advertising campaign data that includes video data and corresponding coupon template data. The campaign data is used to play a video on the display related to the product or service that is being promoted, and to display the related discount coupon. When a user clicks upon the video, the coupon template data is used to present a coupon template on the display. This coupon template can then either be clicked upon to reach the related point of sale page for the product/service so that the user can buy it online, or the coupon can be printed and presented by the user at brick and mortar stores when the advertised product/service is being purchased in order to receive the offered discount.

In other preferred embodiments, when the user clicks upon the video, the client computer opens a coupon form over the webpage and presents the coupon within the coupon form. In certain embodiments the coupon form includes a print button that, when clicked, causes the client computer to print the coupon. In other embodiments the coupon form also includes a close button that, when clicked, causes the coupon template to close.

In another aspect a campaign sever is disclosed. The campaign server includes a processor in communications with memory and networking hardware. The memory includes a campaign database and program code. The campaign database includes video data, coupon template data and campaign identifier information. The program code is executable by the processor to serve video and coupon data to a client computer according to requests received from the client computer. In particular, the campaign server accepts a campaign identifier from the client computer and utilizes the campaign database and the campaign identifier to find related video data and coupon template data within the campaign database. This related video data and coupon template data is then transmitted to the client computer. In preferred embodiments, the coupon template data contains information to print a coupon on a printer that can be accepted at a store, and also contains information for redirecting a computer to a third-party server associated with the coupon so that the coupon may be redeemed via a purchase at an online store.

In other embodiments, the campaign server may serve a specific campaign video based upon a campaign identifier or video identifier, and further serve specific coupon data based upon a coupon identifier.

### BRIEF DESCRIPTION OF THE DRAWINGS

FIG. 1 illustrates a system according to an embodiment method.

FIG. 2 illustrates an embodiment webpage on an end-user computer.

FIG. 3 illustrates an embodiment coupon form on the end-user computer.

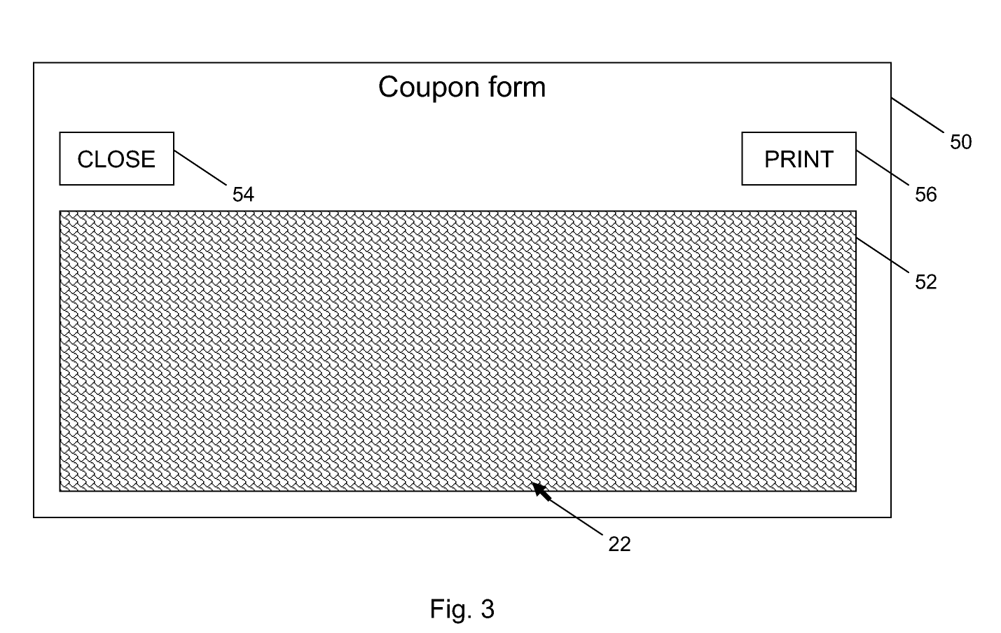

FIG. 4 illustrates embodiment webpage code that produces the webpage shown in FIG. 2.

FIG. 5 is a flow chart according to one embodiment.

FIG. 6 illustrates an embodiment advertising campaign server.

### DETAILED DESCRIPTION

For purposes of the following disclosure, the terms “program code,” “code,” “script,” “scripting code” or the like are intended to mean any machine readable set of logical instructions that causes a computer to perform certain specified tasks. Hence, program code may include, for example, machine language and assembly language. It is also intended to more broadly include, however, other logical languages, such as C++, the .NET framework, JavaScript, Flash, HTML and so forth. The terms “run,” “execute,” “process” and the like are intended to mean that a computer processes the logical instructions present in code to perform the steps indicated by that code. Execution of code may be direct, as with machine code, or may be indirect, as with code that is interpreted (such as HTML), compiled (such as C++) or both (such as Java).

In the following, the term “click” includes that action in which a pointer, typically directed by a user, is placed over a location and then a button associated with the pointer is pressed to generate the “click,” which is a well-known input format used to indicate selection of an item. However, for purposes of the following, the term “click” is further meant to indicate any action by a user that indicates selection of an item. For example, by pressing or tapping upon a touch-sensitive screen, a “click” may be generated. Voice commands may also generate a “click.”

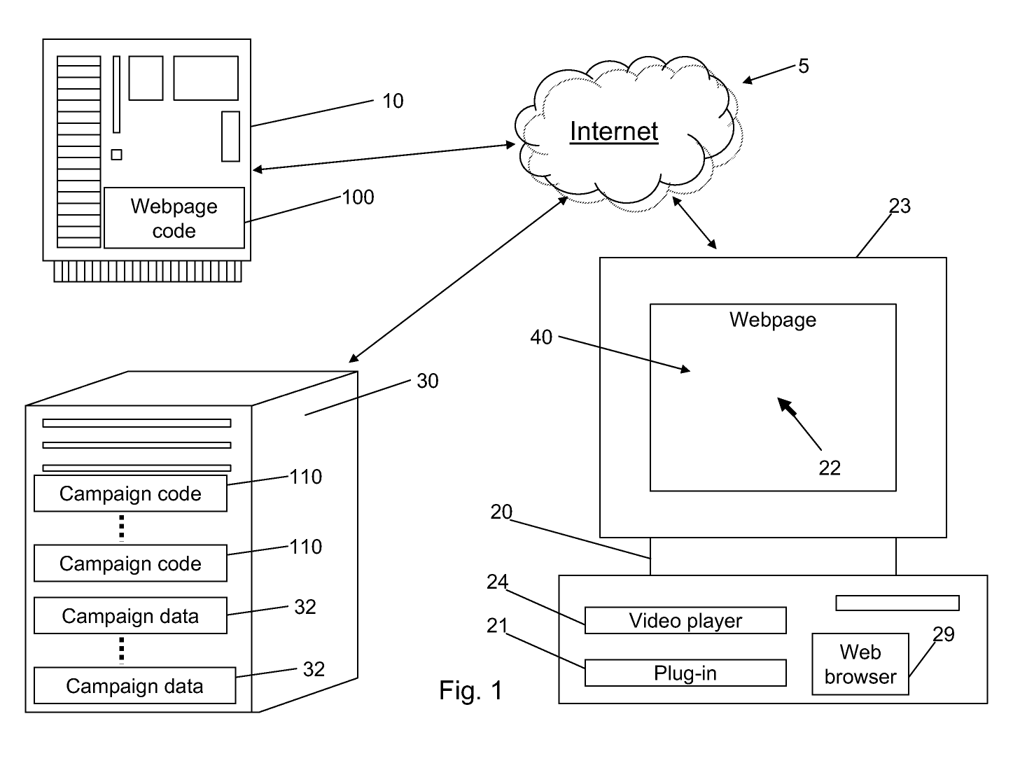

FIG. 1 illustrates a system capable of performing an embodiment advertising method. The system includes a webpage publisher 10, an advertising campaign server 30, and a client computer 20, all of which are in communications with each other via the Internet 5. The webpage publisher 10, when requested by the client computer 20, provides webpage code 100 to the client computer 20. The client computer 20 includes a processor connected to memory, and the memory includes program code executable by the processor, as known in the art, to provide the functionality of the client computer 20. This memory includes a web browser 29 that processes the webpage code 100 to render a corresponding webpage 40 on a display 23 of the client computer 20. The web browser 29 may also call upon a plug-in 21, also residing within the memory of the client computer 20, to assist in the processing of the webpage code 100, as known in the art, to render all or portions of the webpage image 40. Although shown as a single unit or file in the figures, it will be appreciated that the webpage code 100 is, in preferred embodiments, dispersed throughout a plurality of files, not all of which may be present on the webpage publisher 10 but instead present on the campaign server 30 as well as other third-party computers also connected to the Internet 5. These files are called, referenced or otherwise incorporated by instructions within the webpage code 100 present on the webpage publisher 10, as discussed in more detail in the following. Hence, the webpage code 100 is intended to include embodiments utilizing a single file of code 100 and embodiments utilizing multiple files of code 100 distributed across a plurality of servers.

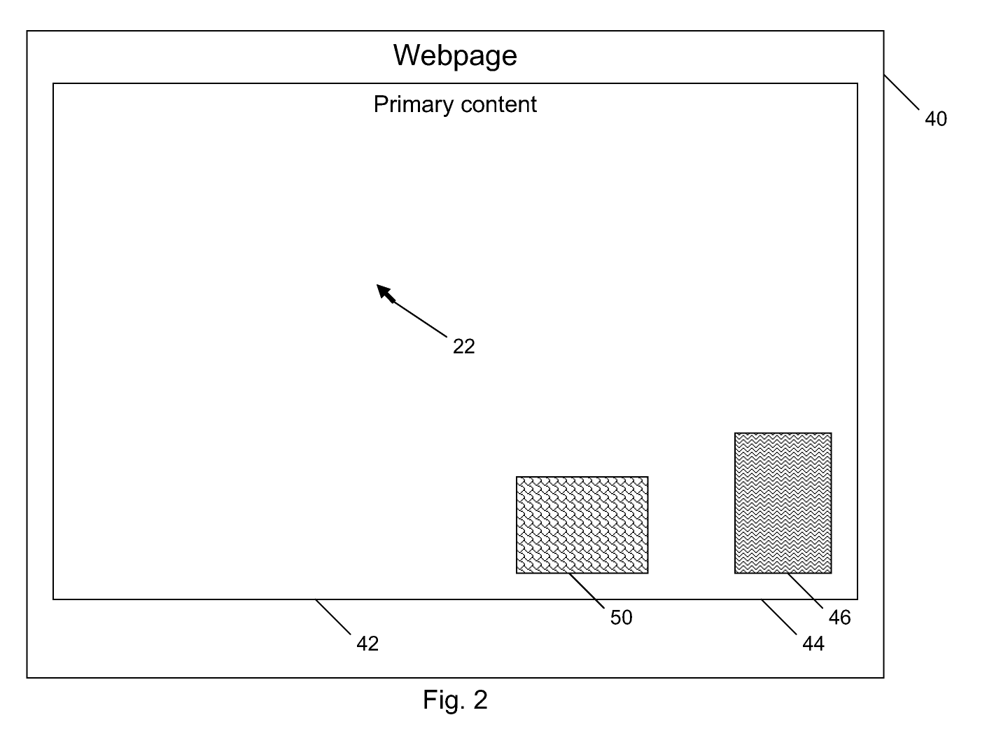

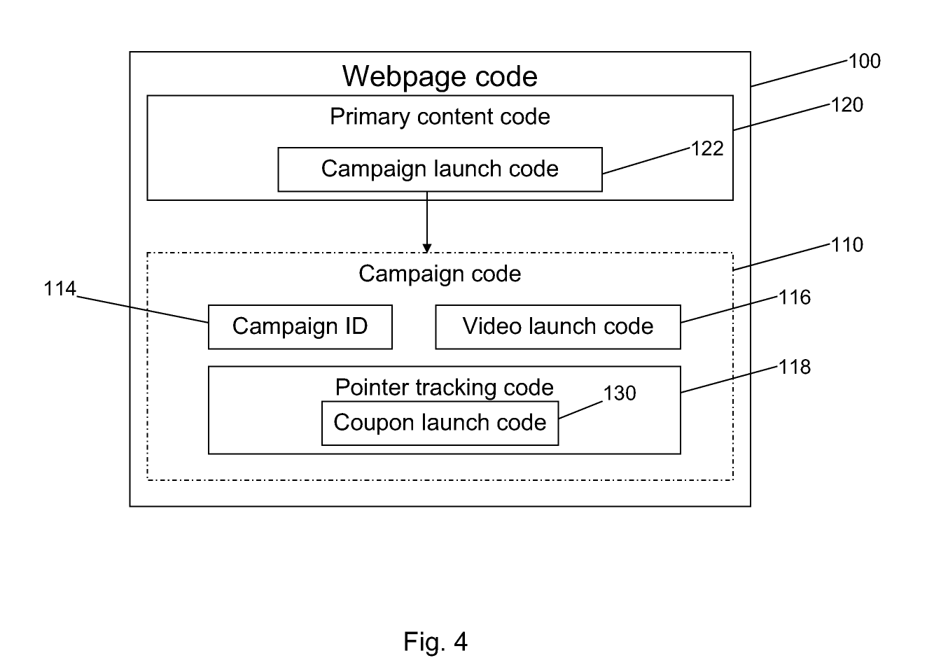

FIG. 2 illustrates one embodiment of the webpage image 40, which is encoded by the webpage code 100 further illustrated in FIG. 4. The webpage image 40 will typically include primary content 42, which is the content 42 that the user of the client computer 20 is primarily interested in. The primary content 42 may also include, for example, banner ads, commercials and the like. When the webpage code 100 is processed by the client computer 20, the webpage code causes campaign data 32 to be downloaded from the campaign server 30, which contains video and coupon data. Using this video data and a video player 24 resident on the client computer 20, the client computer 20 causes a video 46 to appear over the primary content 42. In preferred embodiments, the video player 24 is a Flash player, and is part of a Flash player plug-in 21 installed on the client computer 20. In preferred embodiments, the video 46 presents a celebrity promoting the goods or services of an advertiser, and the video 46 “floats” over the primary content 44. The related plug-in 21 may track scrolling events within the webpage 40 to keep the video 46 positioned within a predetermined location on the screen 23.

When a click is generated for this video 46, such as via pointer 22, the coupon data is used to present a coupon form 50 on the display 23. In some embodiments, the coupon form 50 may also be shown on the display 23 when the video 46 finishes playing, even if there was no click upon the video 46. The coupon form 50 presents a coupon 52 that may be redeemed, for example, in stores or at e-commerce websites. The coupon form 50 may appear, for example, over the webpage 40, preferably near the video 46. In preferred embodiments, the coupon form 50 includes a close button 54 and a print button 56. When the close button 54 is clicked, the coupon form 50 disappears or closes. When the print button 56 is clicked, the webpage code 100 causes the client computer 20 to print out the coupon 52 on a printer connected to the client computer 20 (not shown), thus providing a hard copy of the coupon 52. In other embodiments, when clicked, the coupon form 50 directs the client computer 20 to a server for the goods or services advertised in the coupon 52 so that the coupon 52 may be redeemed at an e-commerce website. The webpage redirected to may be pre-loaded with the goods or services being promoted, as well as with the coupon 52 code, so that the end-user at the client computer 20 can immediately purchase the goods/services with the coupon 52 discount, without needing to enter any data or perform any other additional steps, except to check-out the goods/services to pay for them.

To this end, various embodiments of the webpage code 100 include content code 120 and campaign launch code 122. When rendered, the content code 120 provides the primary content 42 of the webpage 40, whereas the campaign launch code 122 calls other files to provide the functionality of the videos 46 and coupon forms 50. To provide for ease of installation and use for the webpage publisher 10, minimal amounts of launch code 122 are needed on the webpage publisher side 10 to implement the desired functionality; hence the webpage publisher 10 may simply take the webpage code 100 as-is and simply add a small bit of additional launch code 122 to provide embodiment advertising functions. The campaign launch code 122 calls corresponding campaign code 110, which in preferred embodiments is stored on the campaign server 30, and the campaign code 110 then performs the steps necessary to launch the video 46 and coupon form 50 for a particular campaign 32 associated with a campaign identifier (ID) 114. For example, in preferred embodiments the campaign launch code 110 is in the form of HTML code that calls a JavaScript file 110 on the campaign server 30. The JavaScript file 110 in turn causes the Flash video 46 to play and uses Flash to display the coupon form 50. Example campaign launch code 122 could look like this:

<script>
var sid=′82161242827b703e6acf9c726942a1e4′; The campaign ID
var cid=′d67d8ab4f4c10bf22aa353e27879133c′; The associated

coupon ID

var swfheight=310; height of the flash movie
var swfwidth=450; width of the flash movie
var cAutoShow=″20000″; a timeout in milliseconds. Coupons

will be automatically displayed after the timeout

var cheight=220; height of coupon
var cwidth=340; width of coupon
var positionstr=′ right:0px; bottom:0px; ′ ; sets the position

of the Flash movie

var playmethod=′hover′; the event which triggers the video

to start

var elementId=′standalone′; optional. If set specifies which

element in the html will trigger the video start.

</script>
<script type=′text/javascript′

src=′http://www.CampaignServer.com/votf/global/global.j
s′> loads another file which sets up the Flash player
based on the above parameters.

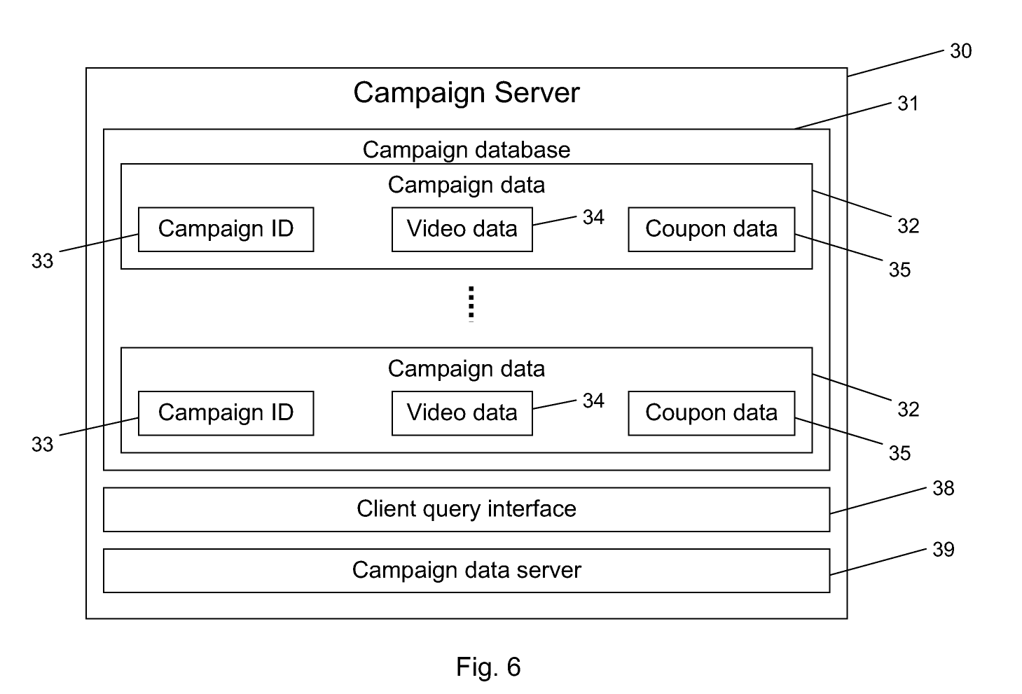

As indicated by the comments in the code above, the variable “sid” may be used, for example, as the campaign ID 114, which is subsequently used by video launch code 116 and coupon launch code 130 to create the video 46 and the coupon form 50. Hence, although the campaign ID 114 is shown as being part of the campaign code 110, it may also be part of the campaign launch code 122 and subsequently accessed by the corresponding campaign code 110. It will be appreciated that the campaign ID need simply be anything that is sufficient to identify a particular campaign 32 on the campaign server 30. For example, the pathname of the campaign code 110 may provide the campaign ID 114, as may the pathnames of the video data 34 of a campaign 32 and/or the coupon data 35 of the campaign 32. The variable “cid” may be used to identify a particular coupon data set 35, which may be used by the campaign code 110, such as the coupon launch code 130, to download the appropriate coupon data 35 without reference to the actual campaign ID 114. In such embodiments, the coupon data 35 within the campaign database 31 may have a related coupon identifier (not shown in FIG. 6). As indicated by the variable “cAutoShow,” the campaign code 110 may also cause the client computer 20 to execute the coupon launch code 130 after a predetermined amount of time has elapsed since launch of, for example, the campaign code 110 generally or the video launch code 116 specifically. The purpose of the other variables is explained in their respective comments.

The campaign code 110 may include the campaign ID 114, and also includes video player launch code 116 and pointer tracking code 118. The campaign ID 114 is used to identify an advertising campaign 32, and is preferably unique to each campaign 32, and may even be unique to each advertiser. The campaign ID 114 may be, for example, the name of the advertiser or campaign, a number or alpha-numeric value identifying the advertiser, or the like. The campaign ID 114 may, for example, be embedded within a file reference associated with the campaign 32, be set within a variable, be carried implicitly in the pathnames of data files 34,35, or by any other suitable manner.

When executed by the client computer 20, the campaign code 110 causes campaign data 32 corresponding to the campaign ID 114 to be downloaded to the client computer 20. This campaign data 32 includes video data 34 and coupon data 35. Video player launch code 116 launches the video player 24 to play the video data 32 as a video 46 that floats over the webpage 40. In other embodiments, the video launch code 116 may contain the URL or like of the video data 34, which would thus act as the campaign ID 114 for such video data 34, or may provide the campaign ID 114 to the campaign server 30, which then uses the campaign ID 114 to obtain and provide the corresponding video data 34. In preferred embodiments the video player 24 is pre-installed on the client computer 20, and may be, for example, a Flash player as provided by a Flash plug-in 21. Any suitable video player 24 and corresponding logical configuration, however, may be used.

In preferred embodiments, the campaign code 110 is pre-programmed to establish a communications connection between the client computer 10 and the campaign server 30. For example, the video player launch code 116 and the coupon launch code 130 may each be pre-programmed with URLs targeting the campaign server 30 for the corresponding video data 34 and coupon data 35; alternatively, the IP address of the campaign server 30, as well as the specific protocol that is to be used for communications, may be pre-programmed into the campaign code 110 to obtain the requisite data 34, 35. In various embodiments, the video player launch code 116 specifically, or the campaign code 110 generally, transmits to the campaign server 30, using the appropriate communications protocol, the campaign ID 114. In preferred embodiments, HyperText Transfer Protocol (HTTP) is used in this query between the user computer 20 and the campaign server 30 to determine if campaign data 32 related to the campaign ID 114 is available.

If the campaign server 30 has campaign data 32 related to the campaign ID 114, then the campaign server 30 begins streaming the related video data 34 to the client computer 20. The video player launch code 116, or the video player 24, receives this video data 34 and plays it as the video 46 floating over the webpage 40. If, however, no related campaign data 32 exists, then the campaign server 30 ignores the request and no video data 34 or coupon data 35 is sent.

The pointer tracking code 118, when executed by the client computer 20, monitors if the pointer 22, or other user input/output (I/O) device, clicks upon the video 46, and contains code to launch the coupon form 50 if such a click occurs. Specifically, when the pointer tracking code 118 receives a signal that the video 46 has been clicked upon, the pointer tracking code 118 calls coupon launch code 130 that opens the coupon form 50 over the webpage 40, and preferably over or near the related advertisement 44. The coupon launch code 130 uses the coupon data 35 within the campaign data 32 to display an image of a coupon 52 within the coupon form 50. Although in preferred embodiments this coupon data 35 is obtained from the campaign server 30, it will be appreciated that it is possible for the coupon data 35 to be obtained from a distinct coupon server. In other embodiments, the campaign code 110 causes the coupon launch code 130 to be executed only when the video 46 ends. In yet other embodiments, the campaign code 110 causes the coupon launch code 130 to be executed after a predetermined amount of time has elapsed. In yet other embodiments, the campaign code 110 causes the coupon launch code 130 to be executed when the video 46 ends or when the video 46 is clicked upon. Variations or combinations of such launching strategies may be employed.

The coupon launch code 130 also creates the close 54 and print 56 buttons within the coupon form 50, and tracks whether the pointer 22, or other user I/O device, clicks upon either of these buttons 54, 56. If the pointer 22 clicks upon the close button 54, or if the webpage 40 is refreshed, such as when the user redirects to another webpage, then the coupon launch code 130 may close the coupon 50. In alternative embodiments, the coupon launch code 130 may keep the coupon 50 open if the webpage 40 is refreshed, however, thus giving the user the ability to eventually print the coupon 52 even while continuing on to other websites. If the print button 56 is clicked, the coupon launch code 56 interfaces with the operating system of the client computer 20 in a known manner to cause the coupon image 52, or a derivative of the image 52, to be sent to a printer driver installed on the client computer 20 to effect printing of the coupon 52. For example, in preferred embodiments that employ Flash to present that coupon form 50, the coupon launch code 130 builds on top of the print functionality offered by the Flash plug-in 21 and the browser 29. The print function provided may be basic in terms of the services or formats offered. However, it will be appreciated that extra processing may be performed to the coupon data 35, such as that used to display the coupon 52, to conform to predetermined constraints; such modified data may then be sent to the printer driver function to effect printing. This printer driver, in turn, controls a printer communicatively connected to the client computer 20 to generate the actual hard copy of the coupon 52 using such data. In this manner, the user of the client computer 20 can obtain a hard copy of the coupon 52 and redeem this coupon 52 at a store, an e-commerce website or the like. In some embodiments, once the coupon launch code 130 has caused the coupon 52 to be printed, the coupon launch code 130 then closes the coupon form 50.

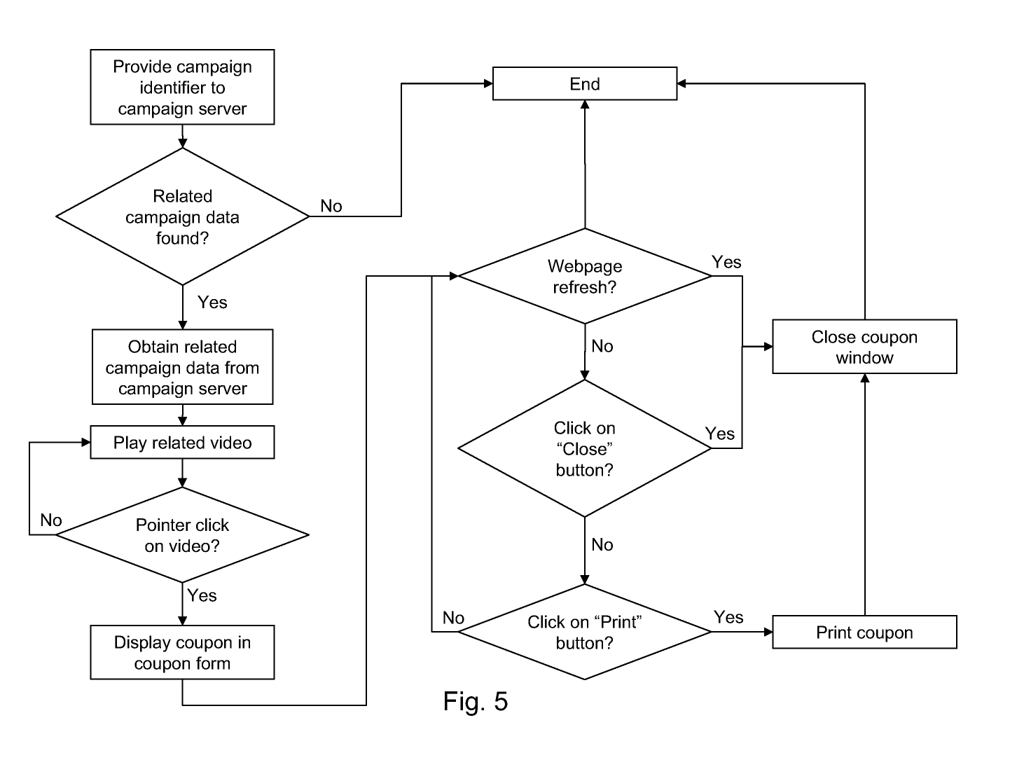

FIG. 5 is a flow chart of one embodiment of the campaign code 110, including the video player launch code 116, the video player 24, pointer tracking code 118 and coupon launch code 130. In a preferred embodiment, once the webpage code 100 has been received from the webpage server 10, the client computer 20 extracts the campaign ID 114 and provides this campaign ID 114 to the campaign server 30. If no related campaign data 32 is present then there is nothing further to do for that particular webpage 40, and the routine 112 ends. On the other hand, if related campaign data 32 is found, then the client computer 20 accepts the related coupon data 35 and the streaming video data 34 and uses the video data 34 to play the video 46 for that advertising campaign. The video 46 is permitted to play while monitoring the pointer 22, or any other suitable user I/O device, to determine if the video 46 has been clicked upon. In some embodiments, the advertisement routine 112 may only respond to a click after the respective video 46 has completed playing. In other embodiments, however, the advertisement routine 112 will respond to a click upon the respective video 46 at any time.

To respond to a click upon the video 46, or perhaps a timeout event, the client computer 20 launches the coupon form 50 and displays the coupon 52 using the coupon data 35 received from the campaign server 30. The client computer 20 then waits until either the webpage 40 is refreshed, the close button 54 is clicked or the print button 56 is clicked. In this embodiment, each of these events will cause the coupon form 50 to close. However, if the print button 56 is clicked, the coupon 52 is also printed. The routine 112 then terminates.

In some embodiments, if the user of the client computer 20 clicks within the coupon form 50, such as on the coupon 52, then the campaign code 110 will cause the computer 20 to redirect to a webpage associated with the coupon 52. This webpage may enable the user to purchase the goods or services being promoted by the coupon 52, as well as having a code associated with the coupon 52 pre-filled so that the user may make use of the coupon 52 at that website. For example, in websites that employ the “shopping cart” model, the website directed to may have a shopping cart loaded both with the advertised good/service, as well as with the appropriate coupon code; hence, the user need simply check-out to pay and receive the discount offered by the coupon 52. By way of example, such a website may have code within the shopping cart code that will identify the shoppers that arrive to the page by clicking on the coupon and will provide such users a special price. Alternatively, the user may print the coupon 52, in which the coupon 52 includes a code number. When completing a purchase, the user may enter the code number printed on the coupon in order to receive the discount.

FIG. 6 illustrates an embodiment campaign server 30. The campaign server 30 is preferably capable of transmitting several gigabytes of video data 34 per second. As known in the art, the campaign server 30 will include one or more processors connected both to memory and input/output devices, such as networking hardware. The memory, working, permanent or both, stores software in the form of instructions executable by the one or more processors, and these instructions, when executed, provide the functionality of the campaign server 30, including the functions described in the following, such as a campaign database 31, a client query interface 38 and a campaign data server 39. Coding such functions in software should be well within the means of one of ordinary skill, after having the benefits of the instant disclosure. Although shown as a single element, it will be appreciated that in practice the campaign server 30 may be provided by a plurality of computer systems, such as blade servers or the like, working together as the campaign server 30, and the software may be so provided.

The campaign server 30 includes a client query interface 38 that is used to communicate with the client computer 20 to accept the campaign ID information 114 and provide the corresponding campaign data 32 in response. The campaign server 30 continuously listens on the client query interface 38 for video 34 requests, coupon data 35 requests, and their associated campaign IDs 114, video or coupon identifiers, URLs, or combinations thereof.

The campaign server 30 includes a campaign database 31 of video data 34 and coupon data 35. The campaign database 31 associates together the video data 34, a campaign ID 33 and the coupon data 35. For example, by presenting a campaign ID 33, the campaign database 31 can provide related video data 34 and coupon data 35. Alternatively, the campaign database 31 may simply be a plurality of data files 34,35, and the campaign ID 33 for a file 34,35 could simply be the URL to that file 34,35. Databases such as the campaign database 31 are well-known in the art, and implementing such a database 31 is well within the means of one of ordinary skill. In preferred embodiments, upon receiving a campaign ID 114, the campaign server 30 searches the campaign database 31 for corresponding campaign data 32. The campaign server 30 parses the associated campaign ID 33, looking for a match with the campaign ID 114 provided by the client computer 20. The campaign server 30 then signals back to the client computer 20, via the client query interface 36, information indicating whether or not a match was found in the campaign database 31. In preferred embodiments, for example, the campaign server may employ the RTMP protocol and HTTP if RTMP is unavailable. The campaign server 30 queries the database 31 located on the server 30 and sends the data 34,35 or both as a response to the request made by a client 20 connection using the same protocol. For example, in preferred embodiments, if matching campaign data 32 is found, the campaign server 30 then sends back video-related data that includes information for the client computer 20 to play the video 46. Such video-related data may include the video data 34 used to display the video 46, a session hash, a video ID, a video path, and video metadata such as video size, client-side configurable data such as a video click-through URL, the volume for the video 46, etc. Some or all of the video-related data may be passed over an HTTP connection. The multimedia server 30 may then begin streaming the video data 32. Preferred embodiments employ Rich Text Messaging Protocol (RTMP) to stream videos 46, and hence open a suitable connection between a data server 39 and the client computer 20 to provide the video data 34 stream. If the RTMP server on the campaign server 30 is down, the campaign server 30 may employ another connection, such as an HTTP connection, to stream the video data 34. The campaign server 30 may then also provide the coupon data 35 to the client computer 20, using, for example an RTMP protocol if available or through an HTTP connection if the RTMP connection is unavailable.

On the other hand, if no matching campaign data 32 is found, the campaign server 30 may not send any information relating to playing the video 46 and instead may close the connection, which may signal that no related campaign data 32 is available. In other embodiments, the campaign server 30 may explicitly signal to the client computer 20 that no matching campaign data 32 is present. In preferred embodiments, the client computer 20 and the campaign server 30 also send and receive data based on various events, such as video 46 start, video 46 stop, etc., using the client query interface 38, which may be done using, for example, the HTTP protocol.

As described above, in preferred embodiments, the campaign ID 114 is used to search for and obtain the related campaign data 32. In certain other embodiments, however, the campaign server 30 may listen on the client query interface 38 for specific file requests, such as for a specific video data file 34 or a specific coupon data file 35; the URL or similar identifier for such a file request may be thought of as the campaign ID 33,114 for that file 34,35. For example, the campaign server 30 may listen on the client query interface 38 for coupon data 34 queries. The query may contain the URL, pathname, identifier or the like for the desired coupon data 35, or may contain the campaign ID 114 for the coupon data 35. If such coupon data 35 is available, the campaign server 30 so signals to the client computer 20, which may be in a manner similar to that used for the video data 34 discussed above. The campaign server 30 then sends the related coupon data 35 to the client computer 20 via the campaign data server 39. A similar procedure may be employed to serve the video data 34 as well. Although shown as a single system 30, it will be appreciated that in certain embodiments the campaign server 30 may be provided by two separate systems, each with its own IP address and database for serving the video data 34 and the coupon data 35, respectively. In such embodiments, the advertisement code 110 may be configured to query the video server for video data requests, and separately query the coupon server for coupon data requests. However, preferred embodiments incorporate both the video data 34 and coupon data 35 within the same server 30 and corresponding campaign database 31; thus, only a single server 30, and hence the same IP address, need be queried for both types of data.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. An advertising method comprising:
receiving webpage data at a client computer;
utilizing at least a portion of the webpage data to present a webpage on a display of the client computer;
utilizing at least a campaign identifier obtained from the webpage data to obtain corresponding video data and coupon data;
utilizing at least a portion of the video data to play a video on the display;
in response to one or more of a click upon the video, a timeout event or the video ending, utilizing at last a portion of the coupon data to present a coupon on the display; and
controlling the client computer to effect printing of the coupon or to connect with another website to redeem the coupon.

2. The method of claim 1 wherein obtaining the corresponding video data comprises:
transmitting at least the campaign identifier or a video identifier to a first server to request the corresponding video data; and
accepting at least the video data from the first server.

3. The method of claim 2 wherein obtaining the corresponding coupon data comprises:
transmitting at least the campaign identifier or a coupon identifier to a second server to request the corresponding coupon data; and
accepting at least the coupon data from the second server.

4. The method of claim 3 wherein the first server and the second server are hosted on the same server.

5. The method of claim 4 wherein the video data and the coupon data are obtained in response to a single request to the first server comprising at least the campaign identifier.

6. The method of claim 1 wherein presenting the coupon on the display of the client computer comprises:
opening a coupon form over the webpage, the coupon form comprising a print button; and
utilizing at least a portion of the coupon data to present the coupon in the coupon form.

7. The method of claim 6 wherein the client computer is controlled to effect printing of the coupon after an action comprising clicking upon the print button.

8. The method of claim 6 further comprising closing the coupon form after effecting printing of the coupon.

9. An advertising campaign server comprising:
a processor;
memory in communications with the processor, the memory comprising:
a campaign database comprising video data, coupon data and associated campaign identifiers; and
program code executable by the processor for performing the following steps:
accepting at least a campaign identifier from a client computer;
utilizing the campaign database and the at least a campaign identifier to find related video data and coupon data within the campaign database; and
transmitting the related video data and coupon data to the client computer; and
networking hardware for establishing communications with the client computer.
